(19) United States
(12) Patent Application Publication
(10) Pub. No.: US 2011/0142248 A1
(43) Pub. Date: Jun. 16, 2011

(54) ACTIVE NOISE CONTROL APPARATUS

(75) Inventors: Kosuke SAKAMOTO, Wako (JP); Toshio Inoue, Wako (JP)

(73) Assignee: HONDA MOTOR CO., LTD., Tokyo (JP)

(21) Appl. No.: 12/943,946

(22) Filed: Nov. 11, 2010

(30) Foreign Application Priority Data
Dec. 14, 2009 (JP) 2009-282448

(51) Int. Cl. G10K 11/16

(52) U.S. Cl. 381/71.4

(57) ABSTRACT

An active noise control apparatus includes a road surface input detector, a reference signal generator, an adaptive filter, a noise-cancellation sound generator, an error detector, a reference signal corrector, a filter coefficient updating unit, a transfer characteristic variation detector, and an update amount controller. The transfer characteristic variation detector is configured to detect a variation in transfer characteristic between the road surface input detector and the error detector. The update amount controller is configured to increase an amount of updating of a filter coefficient to a value greater than a value that is used in a normal mode in accordance with the variation in transfer characteristic detected by the transfer characteristic variation detector.

### CROSS-REFERENCE TO RELATED APPLICATIONS

The present application claims priority under 35 U.S.C. §119 to Japanese Patent Application No. 2009-282448 filed in the Japan Patent Office on Dec. 14, 2009 entitled “Active Noise Control Apparatus”. The contents of this application are incorporated herein by reference in their entirety.

### BACKGROUND OF THE INVENTION

1. Field of the Invention

The present invention relates to an active noise control apparatus.

2. Description of the Related Art

In order to control sound related to vehicle interior vibration noise, active noise control apparatuses (hereinafter simply referred to as “ANC apparatuses”) have been developed. ANC apparatuses output sound waves having a phase opposite to that of vibration noise from a speaker in the vehicle interior so as to reduce the vibration noise. In addition, an error between the vibration noise and noise-cancellation sound is detected in the form of residual noise by a microphone disposed in the vicinity of the ear of a passenger and is used to determine subsequent noise-cancellation sound. For example, some ANC apparatuses reduce road noise generated due to contact of the wheels with a road surface while the vehicle is moving (refer to, for example, Japanese Unexamined Patent Application Publication Nos. 05-265471 and 06-083369). The road noise generating mechanism is very complicated. For example, road noise reaches the ear of a passenger via a variety of routes illustrated in FIG. 6.

Japanese Unexamined Patent Application Publication Nos. 05-265471 and 06-083369 describes generation of noise-cancellation sound using so-called adaptive control (an adaptive filtering process). That is, in Japanese Unexamined Patent Application Publication No. 05-265471, the outputs of vibration sensors (x1, x2, x3, and x4) mounted in a suspension unit are used as reference signals. By performing an adaptive filtering process using an FIR filter, noise-cancellation sound is generated (refer to, in particular, FIG. 4 and Paragraphs [0019] and [0020] of Japanese Unexamined Patent Application Publication No. 05-265471). In contrast, in Japanese Unexamined Patent Application Publication No. 06-083369, a reference signal (x) based on a detection signal of a vibration detecting pickup (1) disposed in a suspension is input to adaptive control circuits (5₁, 5₂) and, subsequently, an adaptive filtering process is performed. Thus, noise-cancellation sound is generated (refer to, in particular, FIG. 1 and Paragraphs [0018] to [0023] of Japanese Unexamined Patent Application Publication No. 06-083369).

In addition, a technology for actively changing the damping characteristic or the spring constant of a suspension has been developed (refer to, for example, Japanese Unexamined Patent Application Publication Nos. 2007-302055, 2006-044523, and 2002-166719). In Japanese Unexamined Patent Application Publication No. 2007-302055, the damping characteristic of a damper of a suspension unit is changed in accordance with the position of a mode change switch (Sm) (refer to, in particular, FIG. 1 and Paragraphs [0015] to [0018] of Japanese Unexamined Patent Application Publication No. 2007-302055). In Japanese Unexamined Patent Application Publication No. 2006-044523, the damping force of a damper is changed by activating an actuator (5) including a core (11) and a coil (12) on the basis of sprung acceleration, the displacement of the damper, the lateral acceleration, and the longitudinal acceleration (refer to, in particular, FIGS. 1 and 2, and Paragraphs [0019] and [0020] of Japanese Unexamined Patent Application Publication No. 2006-044523). Japanese Unexamined Patent Application Publication No. 2002-166719 relates to an air suspension. The spring constant of an air suspension (12) is controlled by opening and closing a control valve (22) (refer to, for example, the summary of Japanese Unexamined Patent Application Publication No. 2002-166719).

As described above, technology for actively controlling the damping characteristic or the spring characteristic of a suspension has been developed. However, the ANC apparatuses described in Japanese Unexamined Patent Application Publication Nos. 05-265471 and 06-083369 do not take into account control in such a case. That is, when the damping characteristic or the spring characteristic of a suspension is changed, the interior noise is also changed. Thus, residual noise detected by a microphone increases. However, in Japanese Unexamined Patent Application Publication Nos. 05-265471 and 06-083369, the increase in residual noise is not taken into account. Accordingly, a long time may be required until the filter coefficient used for adaptive control is converged to a value suitable for the changed damping characteristic or spring characteristic. As a result, the vibration noise reduction performance is temporarily decreased.

This problem widely occurs when the transfer characteristic between a road surface input detecting unit for detecting a road surface input and an error detecting unit for detecting an error between vibration noise and the anti-noise varies in addition to the case in which the damping characteristic or spring characteristic is actively controlled.

### SUMMARY OF THE INVENTION

According to one aspect of the present invention, an active noise control apparatus includes a road surface input detector, a reference signal generator, an adaptive filter, a noise-cancellation sound generator, an error detector, a reference signal corrector, a filter coefficient updating unit, a transfer characteristic variation detector, and an update amount controller. The road surface input detector is configured to detect a road surface input and to generate a road surface input signal representing the road surface input. The reference signal generator is configured to generate a reference signal based on the road surface input signal. The adaptive filter is configured to perform an adaptive filtering process with respect to the reference signal. The adaptive filter is configured to output a control signal that determines noise-cancellation sound of vibration noise based on the road surface input. The noise-cancellation sound generator is configured to generate the noise-cancellation sound based on the control signal. The error detector is configured to detect an error between the vibration noise and the noise-cancellation sound and to generate an error signal representing the error. The reference signal corrector is configured to correct the reference signal based on a transfer characteristic from the noise-cancellation sound generator to the error detector. The reference signal corrector is configured to output a correction reference signal. The filter coefficient updating unit is configured to sequentially update a filter coefficient of the adaptive filter so that the error signal is minimized based on the error signal and based on the correction reference signal. The transfer characteristic variation detector is configured to detect a variation in transfer characteristic between the road surface input detector and the error detector. The update amount controller is configured to increase an amount of updating of the filter coefficient to a value greater than a value that is used in a normal mode in accordance with the variation in transfer characteristic detected by the transfer characteristic variation detector.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a schematic illustration of an exemplary configuration of a vehicle including an active noise control apparatus according to an embodiment of the present invention;

FIG. 2 is a schematic illustration of an exemplary configuration of an acceleration sensor unit disposed in the vehicle and the vicinity thereof;

FIG. 3 is a schematic illustration of an exemplary configuration of the active noise control apparatus;

FIG. 4 is a flowchart of generation of noise-cancellation sound according to the embodiment;

FIG. 5 is a flowchart of a process of changing a step size parameter according to the embodiment; and

FIG. 6 illustrates a road noise generating mechanism.

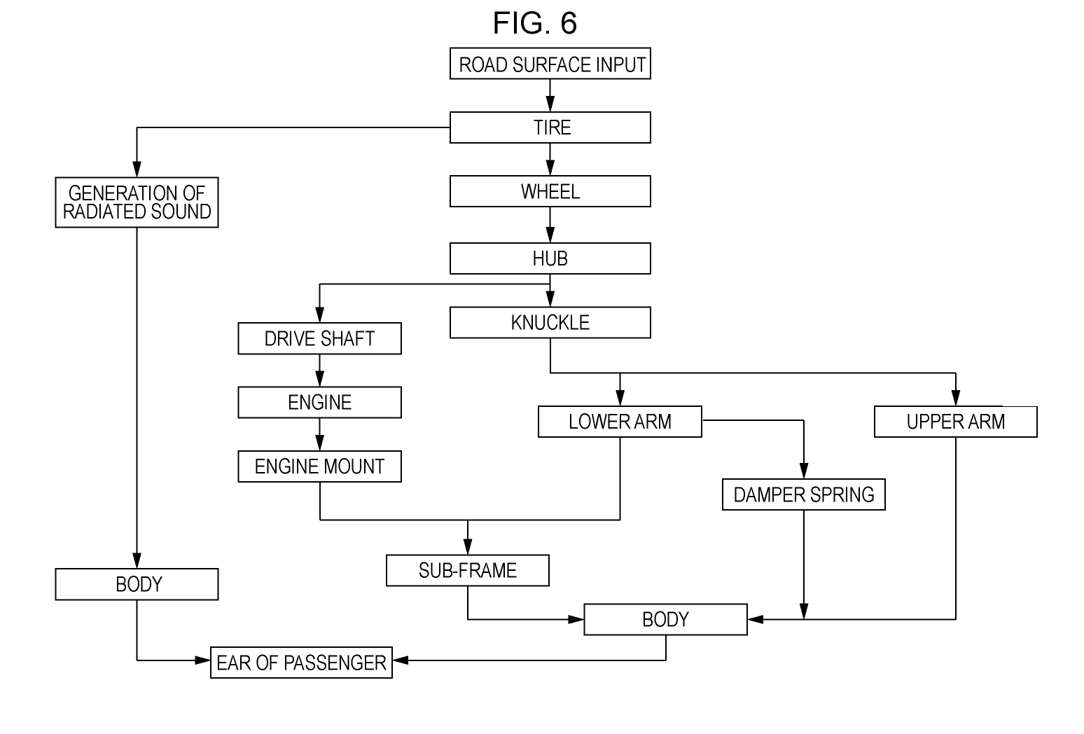

### DESCRIPTION OF THE EMBODIMENTS

An embodiment of the present invention is described below with reference to the accompanying drawings, wherein like reference numerals designate corresponding or identical elements throughout the various drawings.

### 1. Overall Conformation and Configuration of Each Unit

### (1) Overall Conformation

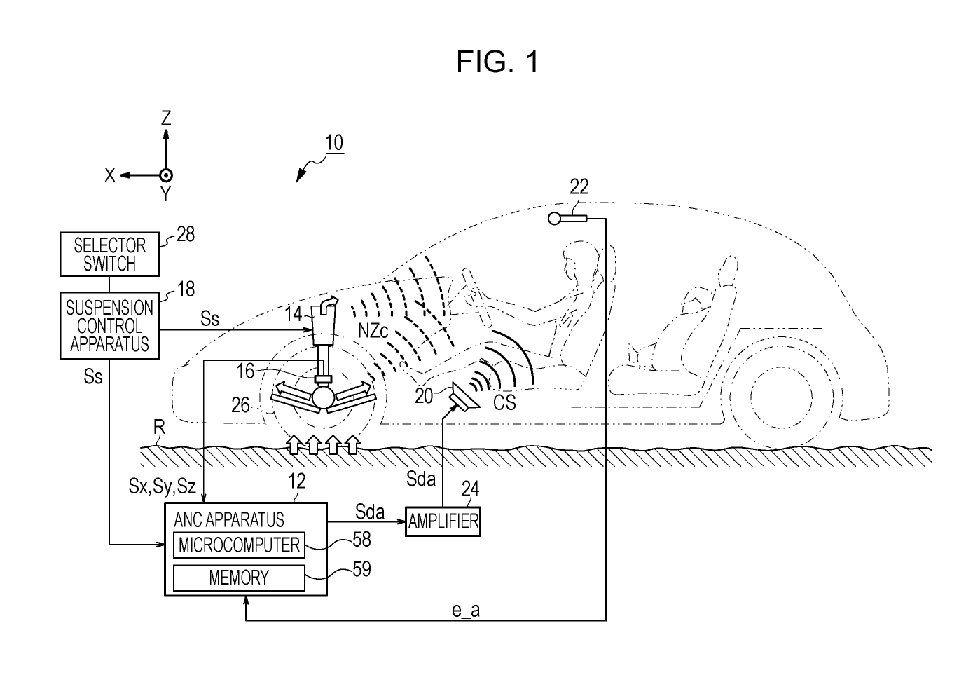

FIG. 1 is a schematic illustration of an exemplary configuration of a vehicle 10 including an active noise control apparatus 12 (hereinafter referred to as an “ANC apparatus 12”) according to an embodiment of the present invention. Examples of the vehicle 10 include a gasoline vehicle, an electric vehicle, and a fuel-cell-powered vehicle.

The ANC apparatus 12 is connected to an acceleration sensor unit 16 mounted in a suspension 14, a suspension control apparatus 18, a speaker 20, and a microphone 22. In addition, an amplifier 24 is disposed between the ANC apparatus 12 and the speaker 20.

The ANC apparatus 12 generates an analog control signal Sda using analog acceleration signals Sx, Sy, and Sz output from the acceleration sensor unit 16, a control signal Ss output from the suspension control apparatus 18, and an analog error signal e_a output from the microphone 22. The analog control signal Sda is amplified by the amplifier 24 and is output to the speaker 20. The speaker 20 outputs noise-cancellation sound CS corresponding to the analog control signal Sda.

Vibration noise in the interior of the vehicle 10 is combination noise NZc that is a combination of vibration noise generated by vibration of an engine (not shown) (hereinafter referred to as “engine muffled sound NZe”) and vibration noise generated by vibration of wheels 26 that are in contact with a road surface R while the vehicle 10 is moving (hereinafter referred to as “road noise NZr”). According to the present embodiment, the ANC apparatus 12 cancels a component of the road noise NZr of the combination noise NZc by using the noise-cancellation sound CS. Thus, a noise-cancellation effect can be obtained.

In addition, the ANC apparatus 12 may have a noise-cancellation function with respect to the engine muffled sound NZe in addition to the road noise NZr. That is, the ANC apparatus 12 can have an existing configuration for reducing engine muffled sound (refer to, for example, Japanese Unexamined Patent Application Publication No. 2004-361721).

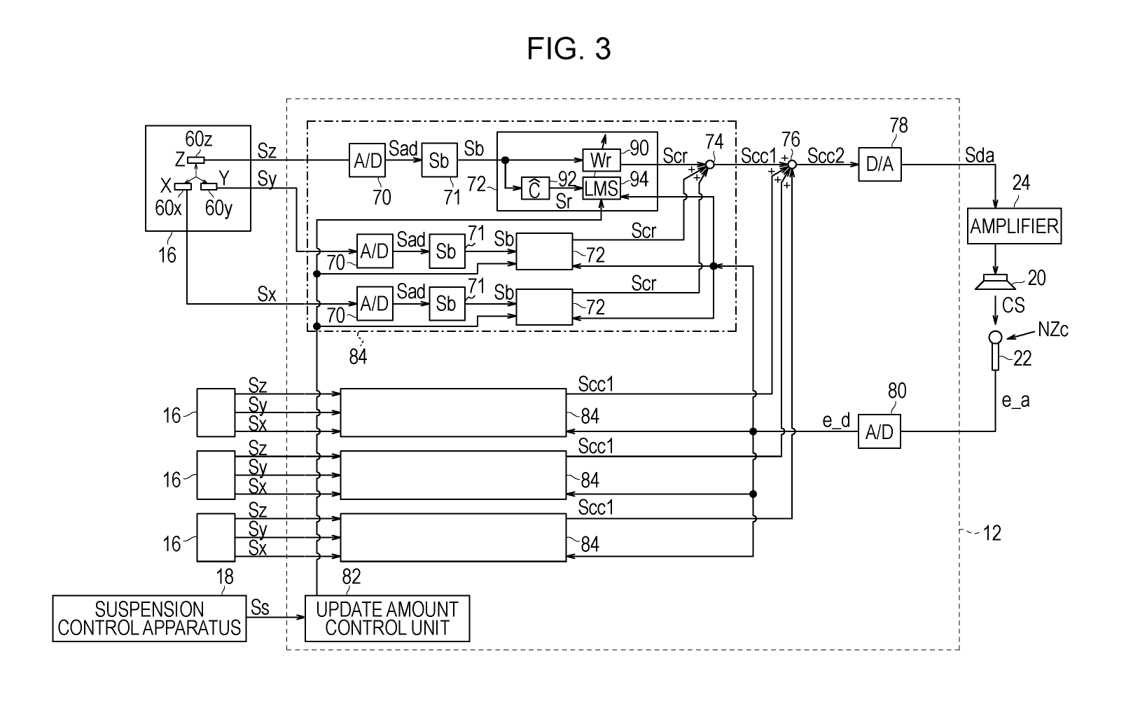

In addition, although not shown in FIG. 1, four acceleration sensor units 16 are provided (refer to FIG. 3). Each of the acceleration sensor units 16 corresponds to one of four wheels 26 (i.e., a left front wheel, a right front wheel, a left rear wheel, and a right rear wheel). Furthermore, for simplicity, only one speaker 20 and only one microphone 22 are shown in FIGS. 1 and 3. However, a plurality of the speakers 20 and a plurality of the microphones 22 can be used in accordance with the use environment of the ANC apparatus 12. In such a case, the number of the other components is changed as appropriate.

### (2) Suspension and Acceleration Sensor Unit

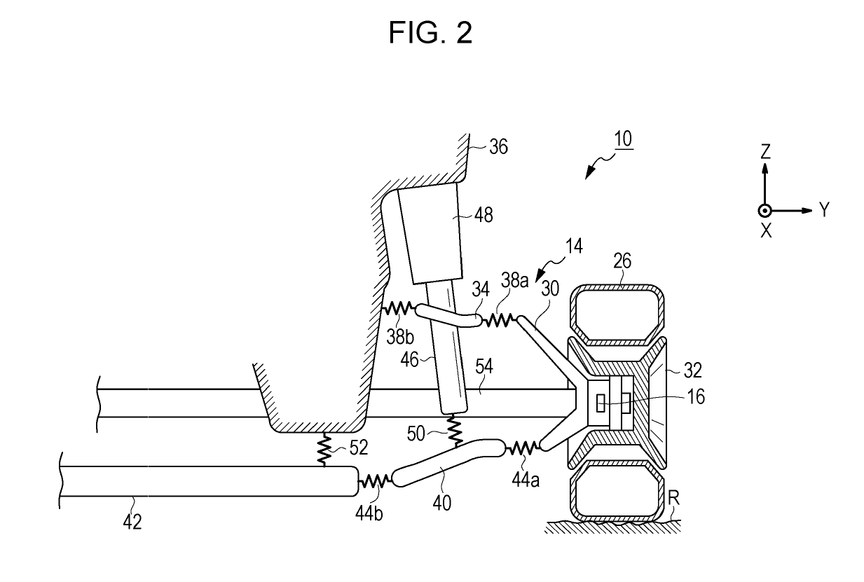

As shown in FIG. 2, in the suspension 14, the acceleration sensor unit 16 is disposed in a knuckle 30 connected to a wheel hub 32 of one of the wheels 26. In addition to the knuckle 30, the suspension 14 includes an upper arm 34 connected to the knuckle 30 and a body 36 via connecting members 38a and 38b, a lower arm 40 connected to the knuckle 30 and a sub-frame 42 via connecting members 44a and 44b, and a damper 46 connected to the body 36 via an actuator 48 and connected to the lower arm 40 via a connecting member 50. The body 36 is connected to the sub-frame 42 via a connecting member 52. A drive shaft 54 extending from the engine is rotatably connected to the knuckle 30.

For example, the damper and the actuator described in Japanese Unexamined Patent Application Publication No. 2006-044523 are used as the damper 46 and the actuator 48, respectively. The actuator 48 varies an electromagnetic force exerted on a core (not shown) disposed in the actuator 48. The core is movable in the forward-backward direction in accordance with the control signal Ss output from the suspension control apparatus 18. In this way, the actuator 48 can change the damping characteristic of the suspension 14. In addition, a damper spring (not shown) is disposed in the vicinity of the actuator 48.

As shown in FIG. 3, each of the acceleration sensor units 16 includes an acceleration sensor 60x for detecting vibration acceleration Ax, an acceleration sensor 60y for detecting vibration acceleration Ay, and an acceleration sensor 60z for detecting vibration acceleration Az. The vibration acceleration Ax detected by the acceleration sensor 60x represents the vibration acceleration [mm/s/s] of the knuckle 30 in the forward-backward direction of the vehicle 10 (the X direction in FIG. 1). The vibration acceleration Ay detected by the acceleration sensor 60y represents the vibration acceleration [mm/s/s] of the knuckle 30 in the left-right direction of the vehicle 10 (the Y direction in FIG. 2). The vibration acceleration Az detected by the acceleration sensor 60z represents the vibration acceleration [mm/s/s] of the knuckle 30 in the upward-downward direction of the vehicle (the Z direction in FIG. 1).

Each of the acceleration sensor units 16 outputs, to the ANC apparatus 12, analog acceleration signals Sx, Sy, and Sz which indicate the vibration accelerations Ax, Ay, and Az detected in the corresponding knuckle 30, respectively.

### (3) Suspension Control Apparatus

The suspension control apparatus 18 switches among the damping characteristics of the suspension 14 in response to a manual operation performed on a selector switch 28 (refer to FIG. 1). For example, the selector switch described in Japanese Unexamined Patent Application Publication No. 2007-302055 can be used as the selector switch 28. Alternatively, the suspension control apparatus 18 can automatically switch among the damping characteristics of the suspension 14 in accordance with, for example, a value detected by an acceleration sensor (not shown) disposed in the upper section of the actuator 48 (above the spring) or a displacement sensor (not shown) disposed on the damper 46. In addition to the damping characteristic in a normal mode, examples of the damping characteristics include a damping characteristic in a sport mode in which the damping force is increased more than that in the normal mode and a damping characteristic in a luxury mode in which the damping force is more decreased than that in the normal mode (refer to Japanese Unexamined Patent Application Publication No. 2007-302055).

### (4) ANC Apparatus

### (a) Overall Conformation

The ANC apparatus 12 controls the noise-cancellation sound CS output from the speaker 20. The ANC apparatus 12 includes a microcomputer 58 and a memory 59 (refer to FIG. 1). The microcomputer 58 can perform a function such as a function of determining the noise-cancellation sound CS (a noise-cancellation sound determination function) through software processing.

FIG. 3 is a schematic illustration of an exemplary configuration of the ANC apparatus 12. As shown in FIG. 3, the ANC apparatus 12 includes a first analog-to-digital converter 70 (hereinafter referred to as a “first A/D converter 70”), a reference signal generation unit 71, and a control signal generation unit 72 provided for each of the acceleration sensors 60x, 60y, and 60z. The ANC apparatus 12 further includes a first adder 74 provided for each of the acceleration sensor units 16, a second adder 76, a digital-to-analog converter 78 (hereinafter referred to as a “D/A converter 78”), and a second analog-to-digital converter 80 (hereinafter referred to as a “second A/D converter 80”), and an update amount controller 82. The reference signal generation unit 71, the control signal generation unit 72, the first adder 74, the second adder 76, and the update amount controller 82 are formed from the microcomputer 58 and the memory 59.

In addition, for simplicity, the first A/D converter 70, the reference signal generation unit 71, the control signal generation unit 72, and the first adder 74 provided for each of the acceleration sensor units 16 are collectively referred to as a “control signal generation unit 84”. In FIG. 3, the interior of only the uppermost control signal generation unit 84 is shown, and the interior of the other control signal generation unit 84 is not shown.

### (b) First A/D Converter

The first A/D converter 70 A/D-converts the analog acceleration signals Sx, Sy, and Sz output from the acceleration sensors 60x, 60y, and 60z, respectively, to a digital format and outputs a digital acceleration signal Sad.

### (c) Reference Signal Generation Unit

The reference signal generation unit 71 generates a reference signal Sb used for controlling an adaptive filter based on the digital acceleration signal Sad output from the first A/D converter 70. Thereafter, the reference signal generation unit 71 outputs the generated reference signal Sb to the control signal generation unit 72.

### (d) Control Signal Generation Unit

The control signal generation unit 72 performs a adaptive filtering process on the reference signal Sb output from the reference signal generation unit 71 and generates a digital control signal Scr. The control signal generation unit 72 includes an adaptive filter 90, a reference signal correction unit 92, and a filter coefficient updating unit 94.

The adaptive filter 90 is a finite impulse response (FIR) filter. The adaptive filter 90 performs an adaptive filtering process on the reference signal Sb using a filter coefficient Wr and outputs the digital control signal Scr indicating the waveforms of the noise-cancellation sound CS in order to reduce the road noise NZr.

The reference signal correction unit 92 performs a transfer function process on the reference signal Sb output from the reference signal generation unit 71 and generates a correction reference signal Sr. The correction reference signal Sr is used when the filter coefficient updating unit 94 computes the filter coefficient Wr. In the transfer function process, the reference signal Sb is corrected using a transfer function Ĉ (a filter coefficient) of the noise-cancellation sound CS from the speaker 20 to the microphone 22. Note that the transfer function Ĉ used in this transfer function process is a measurement value or an estimated value of an actual transfer function C of the noise-cancellation sound CS from the speaker 20 to the microphone 22.

The filter coefficient updating unit 94 sequentially computes and updates the filter coefficient Wr. The filter coefficient updating unit 94 computes the filter coefficient Wr using adaptive algorithm computation (e.g., a least mean square (LMS) algorithm computation). That is, the filter coefficient updating unit 94 computes the filter coefficient Wr using the correction reference signal Sr output from the reference signal correction unit 92 and the digital error signal e_d output from the second A/D converter 80 so that the square e_d² of the digital error signal e_d is zero.

Note that, according to the present embodiment, the amount of updating of the filter coefficient Wr computed by the filter coefficient updating unit 94 is also controlled by the update amount controller 82. This control is described in more detail below.

### (e) First Adder

Each of the first adders 74 combines the digital control signals Scr output from the control signal generation units 72 and generates a first combined control signal Scc1.

### (f) Second Adder

Each of the second adder 76 combines the first combined control signals Scc1 output from the first adders 74 and generates a second combined control signal Scc2.

### (g) D/A Converter

The D/A converter 78 D/A-concerts the second combined control signal Scc2 output from the second adder 76 into an analog format and outputs the analog control signal Sda.

### (h) Second A/D Converter

The second A/D converter 80 A/D-converts the analog error signal e_a output from the microphone 22 into a digital format and outputs the digital error signal e_d.

### (i) Update Amount Controller

The update amount controller 82 controls an amount of updating of the filter coefficient Wr in accordance with the damping characteristic of the suspension 14. This control is described in more detail below.

### (5) Amplifier

The amplifier 24 is a power amplifier that changes the amplitude of the analog control signal Sda output from the D/A converter 78 through a manual operation performed by a user.

### (6) Speaker

The speaker 20 outputs the noise-cancellation sound CS corresponding to the analog control signal Sda output from the ANC apparatus 12 (the microcomputer 58). In this way, an effect of reducing the road noise NZr can be obtained.

### (7) Microphone

The microphone 22 detects an error between the road noise NZr and the noise-cancellation sound CS in the form of residual noise and outputs the analog error signal e_a representing the residual noise to the ANC apparatus 12 (the microcomputer 58).

### 2. Generation of Noise-Cancellation Sound

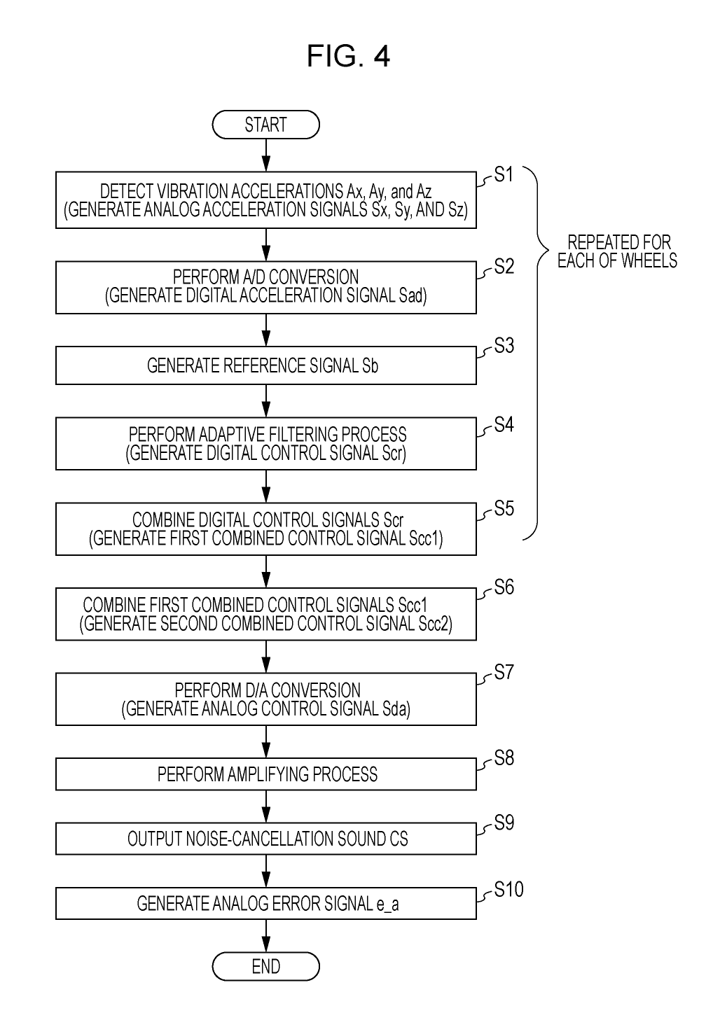

The flow of generation of the noise-cancellation sound CS according to the present embodiment is described next. FIG. 4 is a flowchart of generation of the noise-cancellation sound CS.

In step S1, the acceleration sensors 60x, 60y, and 60z of each of the acceleration sensor units 16 detect the vibration acceleration Ax in the X-axis direction, the vibration acceleration Ay in the Y-axis direction, and the vibration acceleration Az in the Z-axis direction, respectively, and output the analog acceleration signals Sx, Sy, and Sz representing the vibration accelerations Ax, Ay, and Az, respectively.

In step S2, the first A/D converter 70 A/D-converts the analog acceleration signals Sx, Sy, and Sz so as to generate the digital acceleration signal Sad.

In step S3, the reference signal generation unit 71 generates the reference signal Sb based on the digital acceleration signal Sad.

In step S4, each of the control signal generation units 72 performs an adaptive filtering process using the reference signal Sb output from the reference signal generation unit 71 and the digital error signal e_d output from the second A/D converter 80 and generates the digital control signal Scr.

In step S5, the first adder 74 combines the digital control signals Scr output from the control signal generation units 72 and generates the first combined control signal Scc1.

The ANC apparatus 12 performs steps S1 to S5 for each of the four acceleration sensor units 16.

In step S6, the second adder 76 combines the first combined control signals Scc1 output from the first adders 74 and generates the second combined control signal Scc2.

In step S7, the D/A converter 78 D/A-concerts the second combined control signal Scc2 into an analog format and outputs the analog control signal Sda.

In step S8, the amplifier 24 amplifies the analog control signal Sda at a predetermined magnification. In step S9, the speaker 20 outputs the noise-cancellation sound CS based on the amplified analog control signal Sda.

In step S10, the microphone 22 detects a difference between the combination noise NZc including the road noise NZr and the noise-cancellation sound CS in the form of residual noise and outputs the analog error signal e_a corresponding to the residual noise. The analog error signal e_a is used in the subsequent adaptive filtering process performed by the ANC apparatus 12.

The ANC apparatus 12 repeats the above-described steps S1 to S10.

### 3. Process Performed by Filter Coefficient Updating Unit

An exemplary process performed by the filter coefficient updating unit 94 is described next. As noted above, the filter coefficient updating unit 94 sequentially computes and updates the filter coefficient Wr used by the adaptive filter 90. The filter coefficient updating unit 94 computes the filter coefficient Wr using adaptive algorithm computation (e.g., a least mean square (LMS) algorithm computation). That is, the filter coefficient updating unit 94 computes the filter coefficient Wr using the correction reference signal Sr output from the reference signal correction unit 92 and the digital error signal e_d output from the second A/D converter 80 so that the square e_d² of the digital error signal e_d is zero.

More specifically, the following equation is used:

Wr(n+1)=Wr(n)−μ·e_{—}d(n)·Sr(n) (1)

In equation (1), “n” denotes “before update” (the current round), and “n+1” denotes “after update” (the next round). “Wr(n+1)” denotes the filter coefficient Wr used in the next round, and “Wr(n)” denotes the filter coefficient Wr used in the current round. μ denotes a step size parameter, and “e_d(n)” denotes the digital error signal e_d in the current round. “Sr(n)” denotes the correction reference signal Sr at the current round. In a normal mode, the step time parameter is a fixed value (e.g., 0.003).

### 4. Process Performed by Update Amount Controller

The update amount controller 82 controls an amount of updating of the filter coefficient Wr in accordance with the damping characteristic of the suspension 14 controlled by the suspension control apparatus 18.

More specifically, when the damping characteristic of the suspension 14 is changed, the sound pressure of the residual noise detected by the microphone 22 is temporarily increased and, therefore, the value of the analog error signal e_a is temporarily increased. In order to cancel out even small residual noise, the step size parameter μ is determined so that an amount of update Qup of the filter coefficient Wr, that is, a difference Dwr between the filter coefficient Wr(n+1) after update and the filter coefficient Wr(n) before update is relatively small (e.g., μ=0.003). Accordingly, when the damping characteristic of the suspension 14 is changed, a time required until the filter coefficient Wr suitable for the damping characteristic after update is reached is relatively long.

Therefore, when the damping characteristic of the suspension 14 is changed (e.g., when the mode is changed from a normal mode to a sport mode or when the mode is returned from a luxury mode to the normal mode), the update amount controller 82 increases the step size parameter μ of the filter coefficient updating unit 94 (e.g., μ=0.010). That is, a step size parameter μ1 serving as an initial value used in a normal mode is switched to a step size parameter μ2 used when the damping characteristic is changed (μ2>μ1).

In this way, the absolute value of the second term (“−μ·e_d(n)·Sr(n)”) of the right-hand side of equation (1) can be increased. Accordingly, the amount of update Qup of the filter coefficient Wr can be increased. As a result, even when the damping characteristic of the suspension 14 is changed, a time required until the filter coefficient Wr suitable for the damping characteristic after update is reached can be reduced.

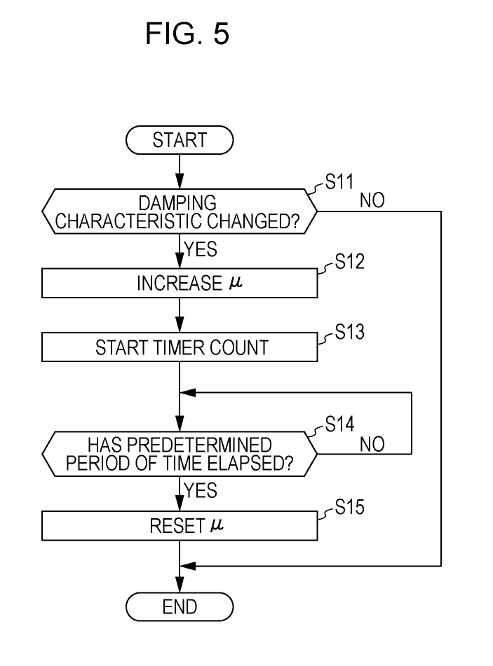

FIG. 5 is a flowchart of a process of changing the step size parameter μ. In step S11, the update amount controller 82 determines whether the damping characteristic of the suspension 14 has been changed. Such determination can be made by using the control signal Ss transmitted from the suspension control apparatus 18 to the update amount controller 82. As described above, the control signal Ss is the same as the signal transmitted from the suspension control apparatus 18 to the actuator 48 in order to control the damping characteristic of the suspension 14. Accordingly, the update amount controller 82 can recognize that the damping characteristic of the suspension 14 has been changed by using the control signal Ss. Note that in step S11, only the occurrence of change in the damping characteristic is determined. However, the level of the change in the damping characteristic may be detected, and the step size parameter μ may be varied based on the level of the change.

If the damping characteristic has been changed (YES in step S11), the processing proceeds to step S12. However, if the damping characteristic has not been changed (NO in step S11), the processing in the current round is completed.

In step S12, the update amount controller 82 increases the step size parameter μ used in the filter coefficient updating unit 94 (e.g., μ=0.010). Thus, the filter coefficient Wr can be promptly converged to a value suitable for the changed damping characteristic.

In step S13, the update amount controller 82 starts a timer TMR that indicates a time period during which the step size parameter μ is increased.

In step S14, the update amount controller 82 determines whether a predetermined period of time has elapsed after the step size parameter μ has been increased. That is, the update amount controller 82 determines whether the value of the timer TMR is greater than or equal to a period of time TH_tmr [ms] which is a period of time during which the step size parameter μ is increased.

If the predetermined period of time has not elapsed (NO in step S14), step S14 is repeated in order to maintain the state in which the step size parameter μ is increased. However, if the predetermined period of time has elapsed (YES in step S14), the update amount controller 82, in step S15, resets the step size parameter μ. Thus, the step size parameter μ returns to the initial value used in a normal mode (μ=0.003). That is, a step size parameter μ2 used after the damping characteristic has been changed is switched to the step size parameter μ serving as an initial value used in a normal mode (μ1<μ2).

### 5. Advantage of Present Embodiment

As described above, according to the present embodiment, when the damping characteristic of the suspension 14 is changed by the suspension control apparatus 18, the step size parameter μ used in the filter coefficient updating unit 94 is temporarily increased and, therefore, the amount of update Qup of the filter coefficient Wr is increased. In this way, even when the sound pressure of residual noise is increased due to a change in the damping characteristic, the filter coefficient Wr can be promptly converged to a value suitable for the changed damping characteristic. Accordingly, a high vibration noise reduction performance can be maintained.

### B. Application of the Invention

It should be noted that the present invention is not limited to the above-described embodiment. A variety of configurations can be employed on the basis of the above-described technique. For example, the following configuration can be employed.

While the foregoing embodiment has been described with reference to the acceleration sensor unit 16 provided for each of the four wheels 26, the acceleration sensor unit 16 may be provided for only one of the wheels 26. In addition, while the foregoing embodiment has been described with reference to the acceleration sensor units 16 that detects the vibration accelerations Ax, Ay, and Az regarding vibration in the three axis directions (the X-axis direction, Y-axis direction, and Z-axis direction), the present invention is not limited thereto. The acceleration of vibration in only one axis direction, two axis directions, or four or more axis directions may be detected.

While the foregoing embodiment has been described with reference to the case in which the vibration accelerations Ax, Ay, and Az are directly detected by the acceleration sensors 60x, 60y, and 60z, respectively, the vibration accelerations Ax, Ay, and Az can be detected by detecting the displacement [mm] of the knuckle 30 using a displacement sensor and performing computation using the displacement. Similarly, the vibration accelerations Ax, Ay, and Az may be computed by using a value detected by a load sensor.

While the foregoing embodiment has been described with reference to each of the acceleration sensor units 16 disposed in the knuckle 30, the acceleration sensor unit 16 can be disposed in the other part, such as a hub.

While the foregoing embodiment has been described with reference to the case in which the step size parameter μ is increased when the damping characteristic of the suspension 14 is changed, the present invention is not limited thereto if the step size parameter μ is increased when the transfer characteristic from each of the acceleration sensors 60x, 60y, and 60z to the microphone 22 varies. For example, the step size parameter μ may be increased when a steering angle is changed, a seat position is changed in a system in which a microphone is attached to the seat, a window is open or closed, the degree to which the window is open or closed is changed, the sunroof is open or closed, or the degree to which the sunroof is open or closed is changed.

While the foregoing embodiment has been described with reference to the case in which the step size parameter μ is varied when the damping characteristic of the suspension 14 is changed, the present invention is not limited to such a case. For example, when the damping characteristic of the suspension 14 is changed, the following equation may be employed:

Wr(n+1)=Wr(n)−μ·α·e_{—}d(n)·Sr(n) (2)

In equation (2), “α” denotes the coefficient of e_d(n) in the current round. The coefficient α is greater than 1 (e.g., α=3). The other symbols are the same as those in equation (1) (this also applies to equations (3) and (4) described below). Even when equation (2) is used, an advantage that is the same as that of equation (1) can be provided. In addition, as a configuration in which the error signal e_d(n) is multiplied by the coefficient α, the configuration that changes the expressions in the filter coefficient updating unit 94 can be employed. Alternatively, the configuration may be a configuration in which an amplifier is disposed between the microphone 22 and the second A/D converter 80 or a configuration in which an amplifier is disposed between the second A/D converter 80 and the filter coefficient updating unit 94.

Alternatively, when the damping characteristic of the suspension 14 is changed, the following equation can be employed:

Wr(n+1)=Wr(n)−μ·e_{—}d(n)·β·Sr(n) (3)

In equation (3), β denotes the coefficient of the correction reference signal Sr(n) in the current round. The coefficient β is greater than 1 (e.g., β=3). Even when equation (3) is used, an advantage that is the same as that of equation (1) can be provided. In addition, as the configuration in which the correction reference signal Sr(n) is multiplied by the coefficient β, a configuration that changes the expressions in the filter coefficient updating unit 94 can be employed. Alternatively, the configuration may be a configuration in which an amplifier is disposed between the reference signal generation unit 71 and the reference signal correction unit 92 or a configuration in which an amplifier is disposed between the reference signal correction unit 92 and the filter coefficient updating unit 94.

Still alternatively, when the damping characteristic of the suspension 14 is changed, the following equation can be employed:

Wr(n+1)={Wr(n)−μ·e_{—}d(n)·Sr(n)}·γ (4)

In equation (4), γ denotes a coefficient of the filter coefficient Wr(n) before update. The coefficient γ is greater than 1 (e.g., γ=3). Even when equation (4) is used, an advantage that is the same as that of equation (1) can be provided. In addition, as the configuration in which the filter coefficient Wr(n) is multiplied by the coefficient γ, the configuration that changes the expressions in the filter coefficient updating unit 94 can be employed. Alternatively, the configuration may be a configuration in which an amplifier is disposed between the adaptive filter 90 and the filter coefficient updating unit 94.

Yet still alternatively, when the damping characteristic of the suspension 14 is changed, the frequency of updating of the adaptive filter 90 can be increased. For example, normally, the adaptive filter 90 is updated once per N₁ times for the sampling period. By changing the frequency to once per N₂ times (N₁>N₂) when the transfer characteristic varies, the frequency of updating is increased. This technique can also provide the same advantage.

While the foregoing embodiment (the flowchart in FIG. 5) has been described with reference to the case in which the step size parameter μ is increased for a certain period of time (refer to steps S13 to S15 in FIG. 5), the present invention is not limited thereto. For example, the step size parameter μ may be increased until the error signal e_d becomes smaller than or equal to a predetermined threshold value TH_ed. Note that the threshold value TH_ed is used for determining whether the filter coefficient Wr is converged to a value in the range suitable for the changed damping characteristic.

While the foregoing embodiment has been described as using, as the suspension 14, an electromagnetic suspension that is similar to the electromagnetic suspension described in Japanese Unexamined Patent Application Publication No. 2006-044523, the present invention is not limited thereto. For example, an air suspension that is similar to the air suspension described in Japanese Unexamined Patent Application Publication No. 2002-166719 can be used.

While the foregoing embodiment has been described with reference to the case in which the damping characteristic of the suspension 14 is actively controlled, the present invention is also applicable to the case in which the spring characteristic of the suspension 14 is actively controlled. In addition to the case in which the transfer characteristic is changed due to the suspension 14, the present invention is applicable to the case in which the transfer characteristic between a road surface input detector other than the acceleration sensors 60x, 60y, and 60z and the microphone 22 is changed.

According to the embodiment of the present invention, when the transfer characteristic between the road surface input detector and the error detector is varied, an amount of updating of the filter coefficient is increased to a value that is greater than that in a normal mode in accordance with a variation in the transfer characteristic. Accordingly, even when an error between vibration noise and the noise-cancellation sound is increased in accordance with the variation in the transfer characteristic, the filter coefficient can be promptly converged to a value optimal to the transfer characteristic after the variation. As a result, a high vibration noise reduction performance can be maintained.

The update amount controller can increase the amount of updating of the filter coefficient by increasing a step size parameter used in the filter coefficient updating unit to a value greater than a value that is used in a normal mode.

The update amount controller can increase the amount of updating of the filter coefficient by amplifying the error signal to a value greater than a value that is used in a normal mode.

The update amount controller can increase the amount of updating of the filter coefficient by amplifying the correction reference signal to a value greater than a value that is used in a normal mode.

The update amount controller can increase the amount of updating of the filter coefficient by increasing a frequency of updating the filter coefficient.

The update amount controller can increase the amount of updating of the filter coefficient to a value greater than a value that is used in a normal mode for a predetermined period of time after detecting a variation in the transfer characteristic.

The road surface input detector can be formed from an acceleration sensor disposed in a suspension having an actively controllable damping characteristic or spring characteristic, and the transfer characteristic variation detector can detect a variation in the characteristic of the suspension.

The transfer characteristic variation detector can detect one of a change in setting of a spring characteristic of the suspension and a change in setting of a damping characteristic of a damper.

According to the embodiments of the present invention, when the transfer characteristic between the road surface input detector and the error detector is varied, an amount of updating of the filter coefficient is increased to a value that is greater than that in a normal mode in accordance with a variation in the transfer characteristic. Accordingly, even when an error between vibration noise and the noise-cancellation sound is increased in accordance with the variation in the transfer characteristic, the filter coefficient can be promptly converged to a value optimal to the transfer characteristic after the variation. As a result, a high vibration noise reduction performance can be maintained.

Obviously, numerous modifications and variations of the present invention are possible in light of the above teachings. It is therefore to be understood that within the scope of the appended claims, the invention may be practiced otherwise than as specifically described herein.

What is claimed is:

1. An active noise control apparatus comprising:
a road surface input detector configured to detect a road surface input and to generate a road surface input signal representing the road surface input;
a reference signal generator configured to generate a reference signal based on the road surface input signal;
an adaptive filter configured to perform an adaptive filtering process with respect to the reference signal and configured to output a control signal that determines noise-cancellation sound of vibration noise based on the road surface input;
a noise-cancellation sound generator configured to generate the noise-cancellation sound based on the control signal;
an error detector configured to detect an error between the vibration noise and the noise-cancellation sound and to generate an error signal representing the error;
a reference signal corrector configured to correct the reference signal based on a transfer characteristic from the noise-cancellation sound generator to the error detector and configured to output a correction reference signal;
a filter coefficient updating unit configured to sequentially update a filter coefficient of the adaptive filter so that the error signal is minimized based on the error signal and based on the correction reference signal;
a transfer characteristic variation detector configured to detect a variation in transfer characteristic between the road surface input detector and the error detector; and
an update amount controller configured to increase an amount of updating of the filter coefficient to a value greater than a value that is used in a normal mode in accordance with the variation in transfer characteristic detected by the transfer characteristic variation detector.

2. The active noise control apparatus according to claim 1, wherein the update amount controller is configured to increase the amount of updating of the filter coefficient by increasing a step size parameter used in the filter coefficient updating unit to a value greater than a value that is used in a normal mode.

3. The active noise control apparatus according to claim 1, wherein the update amount controller is configured to increase the amount of updating of the filter coefficient by amplifying the error signal to a value greater than a value that is used in a normal mode.

4. The active noise control apparatus according to claim 1, wherein the update amount controller is configured to increase the amount of updating of the filter coefficient by amplifying the correction reference signal to a value greater than a value that is used in a normal mode.

5. The active noise control apparatus according to claim 1, wherein the update amount controller is configured to increase the amount of updating of the filter coefficient by increasing a frequency of updating the filter coefficient.

6. The active noise control apparatus according to claim 1, wherein the update amount controller is configured to increase the amount of updating of the filter coefficient to a value greater than a value that is used in a normal mode for a predetermined period of time after detecting a variation in the transfer characteristic.

7. The active noise control apparatus according to claim 1,
wherein the road surface input detector comprises an acceleration sensor disposed in a suspension having an actively controllable damping characteristic or spring characteristic, and
wherein the transfer characteristic variation detector is configured to detect a variation in the characteristic of the suspension.

8. The active noise control apparatus according to claim 7, wherein the transfer characteristic variation detector is configured to detect one of a change in setting of a spring characteristic of the suspension and a change in setting of a damping characteristic of a damper.

9. The active noise control apparatus according to claim 2, wherein the update amount controller is configured to increase the amount of updating of the filter coefficient to a value greater than a value that is used in a normal mode for a predetermined period of time after detecting a variation in the transfer characteristic.

10. The active noise control apparatus according to claim 3, wherein the update amount controller is configured to increase the amount of updating of the filter coefficient to a value greater than a value that is used in a normal mode for a predetermined period of time after detecting a variation in the transfer characteristic.

11. The active noise control apparatus according to claim 4, wherein the update amount controller is configured to increase the amount of updating of the filter coefficient to a value greater than a value that is used in a normal mode for a predetermined period of time after detecting a variation in the transfer characteristic.

12. The active noise control apparatus according to claim 5, wherein the update amount controller is configured to increase the amount of updating of the filter coefficient to a value greater than a value that is used in a normal mode for a predetermined period of time after detecting a variation in the transfer characteristic.

13. The active noise control apparatus according to claim 2,
wherein the road surface input detector comprises an acceleration sensor disposed in a suspension having an actively controllable damping characteristic or spring characteristic, and
wherein the transfer characteristic variation detector is configured to detect a variation in the characteristic of the suspension.

14. The active noise control apparatus according to claim 3,
wherein the road surface input detector comprises an acceleration sensor disposed in a suspension having an actively controllable damping characteristic or spring characteristic, and
wherein the transfer characteristic variation detector is configured to detect a variation in the characteristic of the suspension.

15. The active noise control apparatus according to claim 4,
wherein the road surface input detector comprises an acceleration sensor disposed in a suspension having an actively controllable damping characteristic or spring characteristic, and
wherein the transfer characteristic variation detector is configured to detect a variation in the characteristic of the suspension.

16. The active noise control apparatus according to claim 5,
wherein the road surface input detector comprises an acceleration sensor disposed in a suspension having an actively controllable damping characteristic or spring characteristic, and
wherein the transfer characteristic variation detector is configured to detect a variation in the characteristic of the suspension.

17. The active noise control apparatus according to claim 6,
wherein the road surface input detector comprises an acceleration sensor disposed in a suspension having an actively controllable damping characteristic or spring characteristic, and
wherein the transfer characteristic variation detector is configured to detect a variation in the characteristic of the suspension.

18. The active noise control apparatus according to claim 9,
wherein the road surface input detector comprises an acceleration sensor disposed in a suspension having an actively controllable damping characteristic or spring characteristic, and
wherein the transfer characteristic variation detector is configured to detect a variation in the characteristic of the suspension.

19. The active noise control apparatus according to claim 10,
wherein the road surface input detector comprises an acceleration sensor disposed in a suspension having an actively controllable damping characteristic or spring characteristic, and
wherein the transfer characteristic variation detector is configured to detect a variation in the characteristic of the suspension.

20. The active noise control apparatus according to claim 11,
wherein the road surface input detector comprises an acceleration sensor disposed in a suspension having an actively controllable damping characteristic or spring characteristic, and
wherein the transfer characteristic variation detector is configured to detect a variation in the characteristic of the suspension.
